(19) United States
(12) Patent Application Publication
(10) Pub. No.: US 2015/0220164 A1
(43) Pub. Date: Aug. 6, 2015

(54) TECHNIQUES FOR USING A CABLE AS AN INPUT DEVICE

(71) Applicant: INTEL CORPORATION, Santa Clara, CA (US)

(72) Inventor: Glen J. Anderson, Beaverton, OR (US)

(21) Appl. No.: 14/129,937

(22) PCT Filed: Jun. 27, 2013
(86) PCT No.: PCT/US13/48063

§ 371 Date: Dec. 28, 2013

(51) Int. Cl. G06F 3/0338; G06F 3/038

(52) U.S. Cl. CPC G06F 3/0338; G06F 3/038

(57) ABSTRACT

Various embodiments are generally directed to use a cable coupling a computing device and accessory device as an input device in lieu of another accessory device. An apparatus to receive commands includes a processor component, an accessory interface communicatively coupled to the processor component to receive from a sensor of a cable an indication of first movement of the cable, and an interpretation component for execution by the processor component to determine whether the first movement indicates a command and to identify the command. Other embodiments are described and claimed.

### TECHNICAL FIELD

Embodiments described herein generally relate to the use of a cable incorporating sensors as an input device to convey commands to a computing device.

### BACKGROUND

Portable computing devices have continued to become lighter and more compact, while also acquiring greater ranges of capability. However, accessories for use with portable computing devices have made less of such progress. Accessories such as power supplies have been reduced in size and weight, but still must remain large enough to carry a connector to enable being safely coupled to a source of electric power (e.g., a socket for AC mains). User interface accessories such as a mouse, trackball, touchpad, earphones, camera or eyepiece display have also been reduced in size and weight, but still must remain large enough to be manually operable and/or to be worn on a body portion.

Thus, if an operator of a portable computing device desires accessories to listen to music, play a video game, privately watch a video, or record their own speech, the operator must typically carry multiple accessories with their portable computing device to enable performing each of these functions. This often results in the undesired need to carry the portable computing device and its accessories in some form of carrying bag or case, thereby negating the very portability that was sought after in procuring the portable computing device.

The need to support the multiple accessories that an operator may want to use also imposes a trade off in the design of the portable computing devices, themselves. Specifically, choices must be made of how many and/or what types of connectors to provide for the attachment of accessories. The provision of more connectors to accommodate multiple accessories simultaneously often requires a portable computing device to become larger. The provision of fewer connectors to allow a portable computing device to remain smaller often also limits the number of accessories that may be used simultaneously.

### BRIEF DESCRIPTION OF THE DRAWINGS

FIG. 1 illustrates an embodiment of an interaction system.

FIGS. 2A-B each illustrate a cable according to an embodiment.

FIGS. 3A-B each illustrate a cable according to an embodiment.

FIGS. 4A-B each illustrate a cable according to an embodiment.

FIG. 5 illustrates an accessory device according to an embodiment.

FIG. 6 illustrates an example of detection of movement according to an embodiment.

FIG. 7 illustrates a portion of an embodiment.

FIG. 8 illustrates an example of control of a user interface according to an embodiment.

FIGS. 9-10 each illustrate a logic flow according to an embodiment.

FIG. 11 illustrates a processing architecture according to an embodiment.

### DETAILED DESCRIPTION

Various embodiments are generally directed to use a cable coupling a computing device and accessory device as an input device in lieu of another accessory device. The cable incorporates sensors at more than one location along its length to detect indications of physical manipulation of the cable that may be indicative of operator input to convey a command. Such sensors may include an array of pressure and/or other sensors disposed about the cable to detect such as physical manipulation as pinching, stroking and/or bending of the cable that can cause movement of one portion of the cable relative to another. Where pressure sensors are so incorporated, one or more minimum and/or maximum pressure thresholds may be selected to distinguish operator input to convey a command from other events that physically manipulate the cable in a manner detectable by the pressure sensors (e.g., bending caused by dangling of the cable when suspended by its ends between two devices, pinching caused by an object set on top of a portion of the cable, etc.).

In addition to sensors disposed along the length of the cable, the accessory device coupled to the computing device via the cable may incorporate one or more sensors to detect motion as still more operator input to convey a command. Such sensors may include one or more of a magnetic compass, an accelerometer and a gyroscope. Where such sensors are so incorporated, patterns of translational and/or rotational movement of the accessory by the operator may be detected. One or more thresholds of speed, direction and/or acceleration may be selected to distinguish intended operator input to convey a command from other movement.

With the incorporation of at least the sensors within the cable, the cable itself is able to be manually operated as an input device by manipulating it in various ways, thereby precluding a need for an additional accessory device configured to be operated as an input device. As a result, the accessory device coupled via the cable to the computing device may be configured to serve a function entirely unrelated to accepting operator input to convey commands (e.g., earphones, a camera, a speaker, amplified antenna, etc.).

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will be apparent from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

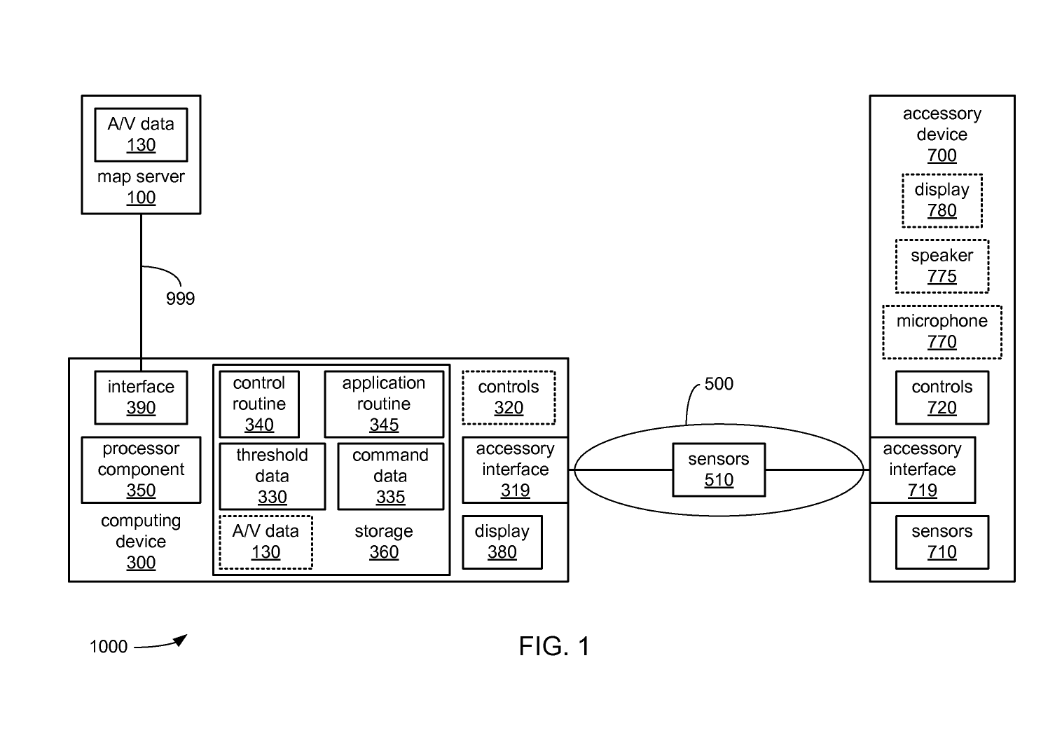

FIG. 1 is a block diagram of an embodiment of an interaction system 1000 incorporating one or more of a server 100, a computing device 300, a cable 500 and an accessory device 700. Each of the computing devices 100 and 300 may be any of a variety of types of computing device, including without limitation, a desktop computer system, a data entry terminal, a laptop computer, a netbook computer, a tablet computer, a handheld personal data assistant, a smartphone, a digital camera, a body-worn computing device incorporated into clothing, a computing device integrated into a vehicle (e.g., a car, a bicycle, a wheelchair, etc.), a server, a cluster of servers, a server farm, etc.

As depicted, the computing devices 100 and 300 exchange signals conveying routines and/or data that is in some way interacted with via manual operation of the cable 500 through a network 999. However, one or more of these computing devices may exchange other data that is in no way interacted with through manual operation of the cable 500. with each other and/or with still other computing devices (not shown) via the network 999. In various embodiments, the network may be a single network possibly limited to extending within a single building or other relatively limited area, a combination of connected networks possibly extending a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission.

In various embodiments, the server 100 may store A/V data 130 for transmission to the computing device 300 via the network 999. The AV data 130 may include an audio and/or visual program for audible and/or visual presentation to an operator of the computing device 300, possibly via the accessory device 700, as will be explained in greater detail.

In various embodiments, the computing device 300 incorporates one or more of a processor component 350, a storage 360, controls 320, a display 380 and an interface 390 to couple the computing device 300 to the network 999. The computing device 300 also incorporates an accessory interface 319 to couple the computing device 300 to the cable 500 and/or the accessory device 700 through the cable 500. The storage 360 stores one or more of a control routine 340, an application routine 345, threshold data 330, a command data 335 and the A/V data 130.

The control routine 340 incorporates a sequence of instructions operative on the processor component 350 in its role as a main processor component of the computing device 300 to implement logic to perform various functions. In executing the control routine 340, the processor component 350 receives indications of possible operator input from at least the cable 500 via the accessory interface 319, if not also the accessory device 700. The control routine 340 may accept such operator input as part of providing a user interface by which the operator of the computing device 300 may control it. Alternatively or additionally, the control routine 340 may relay indications of such operator input to the application routine 345, thereby enabling operator interaction with a user interface of the application routine 345.

In various embodiments, the cable 500 incorporates one or more sensors 510 to detect physical manipulation of the cable 500 that may cause movement of one portion of the cable 500 relative to another and/or that may be indicative of operator input by an operator of the computing device 300 to convey a command to the computing device 300. Each of the one or more sensors 510 may be any of a variety of types of sensor, including and not limited to, pressure sensors, strain sensors, vibration sensors, thermal sensors, light detectors, proximity sensors, etc. One or more of the sensors 510 may be implemented using microelectromechanical systems (MEMS) technology.

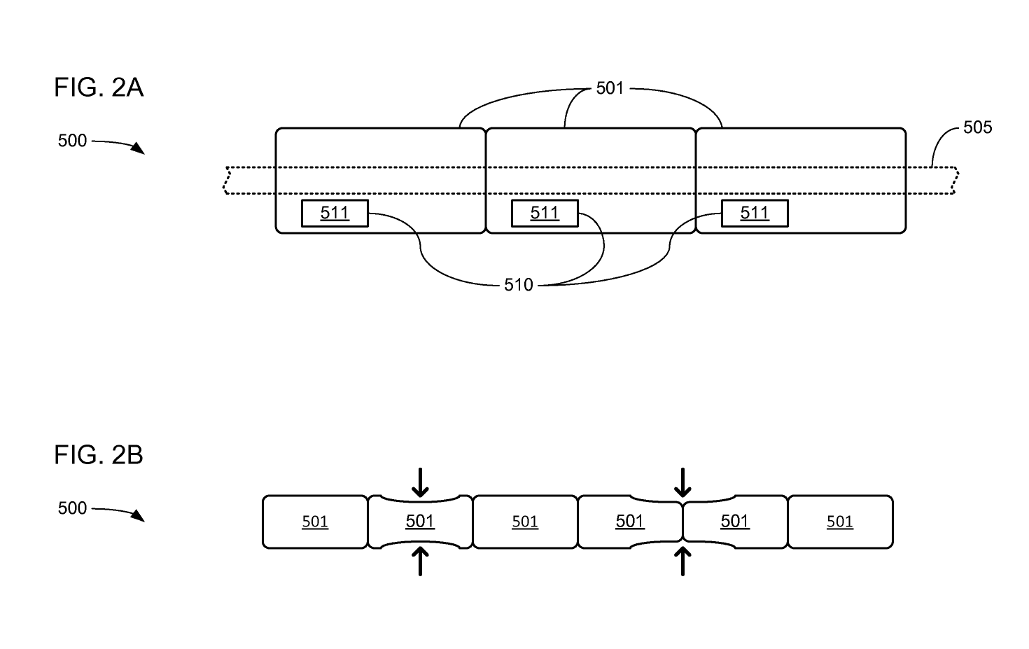

FIGS. 2A-B illustrate features of an embodiment of the cable 500. Turning to FIG. 2A, the cable 500 incorporates multiple enclosed cells 501 that surround at least a portion of an inner jacket 505 and define at least a portion of the exterior of the cable 500. As specifically depicted, the cells 501 have a generally cylindrical outer shape and a generally cylindrical aperture by which the inner jacket 505 extends therethrough in a manner not unlike a string through a bead. Within the enclosed cells 501 are the sensors 510, specifically pressure sensors 511 that sense the pressure of a gas and/or fluid disposed within each of the cells 501. The walls of each of the cells 501 that define their outer cylindrical shape may be formed continuously with an addition cylindrical wall that defines the cylindrical aperture to thereby seal the interior of each of the cells 501 to retain the gas and/or fluid disposed within. Alternatively, the walls of each of the cells 501 that define their outer cylindrical shape may be sealed against the cylindrical exterior surface of the inner jacket 505 at each location where the inner jacket 505 extends through those walls to retain the gas and/or fluid disposed within. The inner jacket 505 surrounds one or more conductors of the cable, including electrical conductors conveying electrical signals and/or optical conductors conveying light signals.

Turning to FIG. 2B, the walls of the cells 501 that define at least a portion of the exterior of the cable 500 are configured to be flexible such that they are able to be deformed in various ways by actions of an operator of the computing device 300 that cause movement of a portion of the external surface of the cable 500 relative to other portions of the cable 500. As specifically depicted, one or more of the cells 501 may be pinched, thereby deforming their walls, moving those walls inward relative to other portions of the cable. Such pinching may be effected by an operator of the computing device 300 with an opposed pair of digits (not shown). Such pinching results in an increase in pressure of the gas and/or fluid within one or more of the cells 501, which is detected by one or more of the pressure sensors 511. In turn, the one or more pressure sensors 511 may transmit signal(s) via the cable 500 to the accessory interface 319, thereby providing indications of manual operation of the cable 500 to the computing device 300.

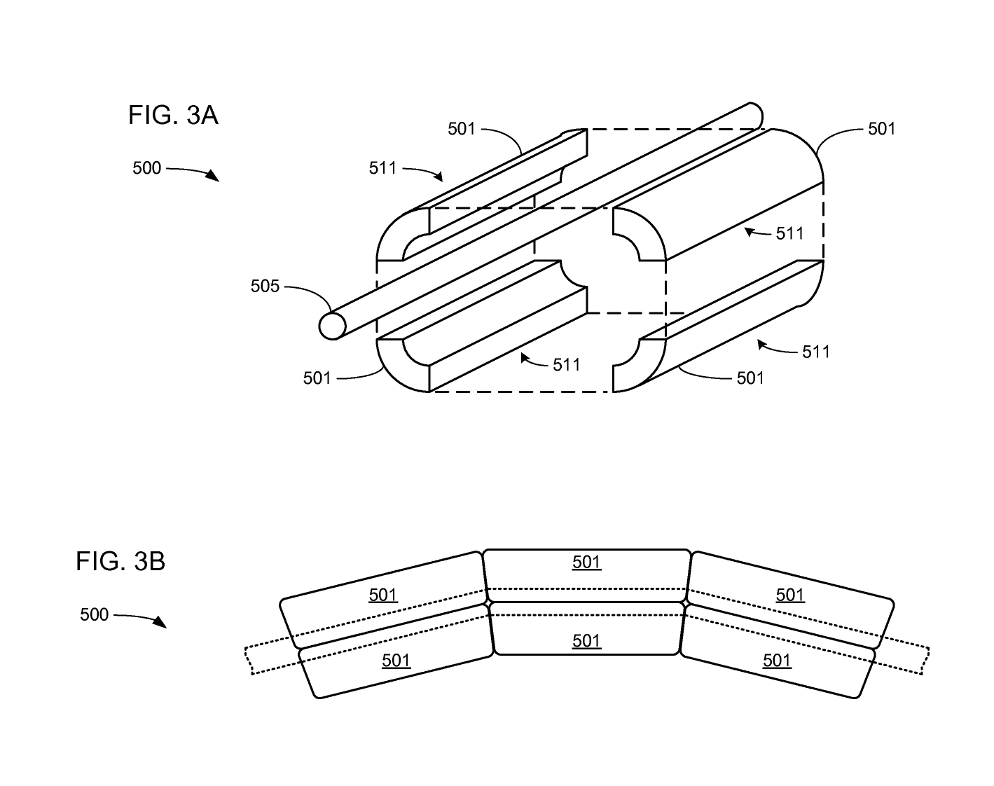

FIGS. 3A-B illustrate features of an embodiment of the cable 500. Turning to FIG. 3A, the cable 500 incorporates at least one set of multiple enclosed cells 501 that surrounds at least a portion of an inner jacket 505 and defines at least a portion of the exterior of the cable 500. As specifically depicted, the cells 501 are each of a shape forming only a portion of a generally cylindrical outer shape and a generally cylindrical aperture by which the inner jacket 505 extends therethrough. Again, within the enclosed cells 501 are the pressure sensors 511 that sense the pressure of a gas and/or fluid disposed within each of the cells 501.

Turning to FIG. 3B, with a set of cells 501 surrounding the inner jacket 505 (instead of a single cell 501 as depicted in FIGS. 2A-B), bending of the cable 500 (such that portions of walls on opposite sides of the cable 500 are moved relative to each other as one portion of the length of the cable 500 is moved relative to another) is able to be detected as differences in pressure between cells 501 that are disposed on opposite sides of the cable 500. As specifically depicted, ones of the cells 501 disposed on the outer side of a bend in the cable 500 tend to be stretched, while ones of the cells 501 disposed on the inner side of the bend tend to be compressed. Thus, pressure sensors 511 in ones of the cells 501 on the outer side of a bend may detect a reduction in pressure, while pressure sensors 511 in ones of the cells 501 on the inner side of the bend may detect an increase in pressure.

It should be noted that despite the specific depiction of four of the cells 501 forming a generally cylindrical structure that surrounds the inner jacket 505 in FIG. 3A, such a structure may be formed using other numbers of the cells 501, and each of those cells 501 may have a shape that differs from what is depicted in FIG. 3A. It should also be noted that despite the specific depiction and discussion of cylindrical shapes formed by one or more of the cells surrounding the inner jacket 505 in FIGS. 2A-B and 3A-B, other entirely different shapes may be employed (e.g., ring shapes, spherical shapes, rectangular shapes, elliptical shapes, etc.). Indeed, irregular shapes may be employed to provide texturing of the portion of the outer surface of the cable 500 that the cells 501 define, possibly to provide a tactile guide to an operator of particular locations along the length of the cable 500.

It should be further noted that the depiction of the use of the cells 501 filled with gas and/or fluid monitored by the pressure sensors 511 depicted in FIGS. 2A-B and 3A-B are but examples of a mechanism by which forms of physical manipulation of the cable 500 such as pinching, stroking and/or bending may be detected. Thus, the presentation of such embodiments should not be taken as limiting. As previously discussed, entirely different sensors may be employed in lieu of or in addition to the pressure sensors 511 to detect physical manipulation of the cable 500 that may cause movement of one or more portions relative to one or more other portions, and structures either similar to or entirely different from the cells 501 that may provide portions that are so moved may be employed in cooperation with those different sensors.

It should be still further noted that despite these depictions of the cable 500 with its exterior surface substantially uncovered by other objects, embodiments are possible in which the cable 500 is integrated into other objects, such as clothing (e.g., a scarf or belt through which the cable 500 extends). In still other embodiments, the cable 500 may be bundled with one or more other cables or cords.

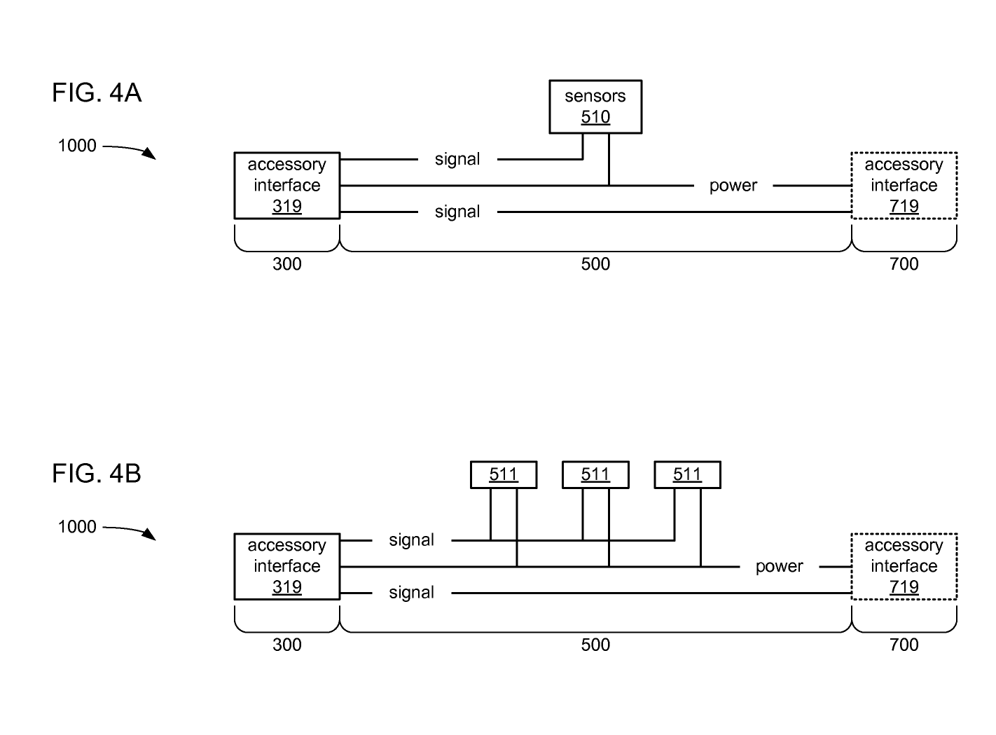

FIGS. 4A and 4B illustrate possible electrical architectures of an embodiment of the cable 500. Turning to FIG. 4A, the cable 500 may incorporate one or more power conductors to convey electric power among the computing device 300, the sensors 510 and the accessory device 700. In some embodiments, the computing device 300 provides electric power to one or both of the sensors 510 and the accessory device 700 as needed. However, it may be that one or both of the sensors 510 and the accessory device 700 have access to their own source(s) of electric power or incorporate component not requiring the provision of electric power.

Also, the cable 500 may incorporate one or more electrical and/or optical conductors to convey signals between at least the computing device 300 and the accessory device 700. Alternatively or additionally, the cable 500 may incorporate one or more electrical and/or optical conductors to convey signals between the sensors 510 and the computing device 300. However, in other embodiments, at least some of the exchange of signals among two or more of the computing device 300, the sensors 510 and the accessory device 700 may be performed wirelessly (e.g., via near-field radio frequency communication, etc.). Regardless of the manner in which signals are conveyed, signals emanating from the sensors 510 may convey indications of physical manipulation of the cable 500 detected by the sensors 510 that may represent operator input to convey a command, and/or signals emanating from the accessory device 700 may convey other indications of what may be other operator input to convey a command detected by the sensors 710.

It should be further noted that power and signal conductors of the cable 500 may be combined in various ways appreciable by those skilled in the art. By way of example, power conductors to convey power among the computing device 300, the sensors 510 and/or the accessory device 700 may also convey radio frequency signals by which the indications of what may be operator input may be conveyed. Thus, there may be as few as two electrical conductors within the cable 500 to both convey electric power and signals, or there may be as few as a single conductor within the cable 500 to convey solely signals. By way of another example, there may be a common ground and/or shield conductor paired with (e.g., providing a current return path for) both power and signal conductors.

FIG. 4B more specifically illustrates an embodiment of an electrical architecture that may be employed by embodiments of FIGS. 2A-B and/or 3A-B that incorporate the pressure sensors 511. As specifically depicted, the cable 500 may incorporate one or more power conductors to convey electric power to the sensors 510, and one or more signal conductors to receive therefrom signals conveying indications of detected physical manipulation of the cable 500 that may be indicative of operator input to convey a command. These conductors may be in addition to and/or may be shared with one or more conductors conveying power and/or signals between the computing device 300 and the accessory device 700.

It should be noted that the cable 500 may be detachable from one or both of the computing device 300 and the accessory device 700. More specifically, the accessory interfaces 319 and/or 719 may each incorporate one or more connectors enabling the cable 500 to be detached therefrom.

Returning to FIG. 1, in various embodiments, the accessory device 700 incorporates one or more of sensors 710, controls 720, a display 780, a microphone 770 and one or more speakers 775. The accessory device 700 also incorporates an accessory interface 719 to couple the accessory device 700 to the cable 500 and/or the computing device 300 through the cable 500.

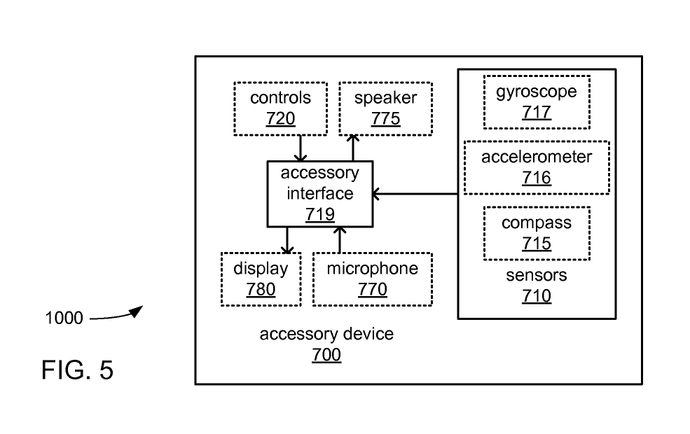

FIG. 5 illustrates an embodiment of the accessory device 700. As specifically depicted, the sensors 710 may incorporate one or more of a compass 715 to detect a magnetic compass heading, one or more accelerometers 716 to detect the magnitude and/or direction of one or more translational accelerations, and/or a gyroscope 717 to detect the extent of rotation of a rotational motion. As with the sensors 510, one or more of the sensors 710 may be implemented using MEMS technology. Which of the controls 720, the microphone 770, the speaker 775 and the display 780 are incorporated into the accessory device 700 may be determined by its function. Where the accessory device 700 is an earphone or headphone, it may incorporate one or more of the speaker 775. Where the accessory device 700 is an earphone or headphone configured for two-way voice communications, it may additionally incorporate the microphone 770. Where the accessory device 700 is a mouse, touchpad, trackball or other form of manually operable input device enabling interaction with a user interface of the computing device 300, it may incorporate the controls 720 (e.g., buttons, slide switches, rotary knobs, a touch-sensitive surface, etc.).

In still other possible embodiments, the accessory device 700 may be any of a variety of biometric detection devices worn to monitor parameters of a body. By way of example, the accessory device 700 may measure brain activity and/or blood flow correlated to brain activity via electroencephalography (EEG) or functional near-infrared (fNIR) spectroscopy. Further, such detected brain activity may be used to augment physical manipulation of the cable 500 (that may cause movement of one or more portions of the cable 500 relative to one or more other portions of the cable 500) and/or movement of the device 700 to provide operator input to the computing device 300. By way of example, a detected pattern of brain activity previously determined to be associated with listening to music may be detected and interpreted as a command to play music, while physical manipulation of the cord may convey commands to in some way adjust the playing of the music (e.g., adjust the volume, select a track, etc.) It should be noted that these are but examples of functions that the accessory device 700 may perform and combinations of components that may be incorporated therein, and should not be taken as limiting.

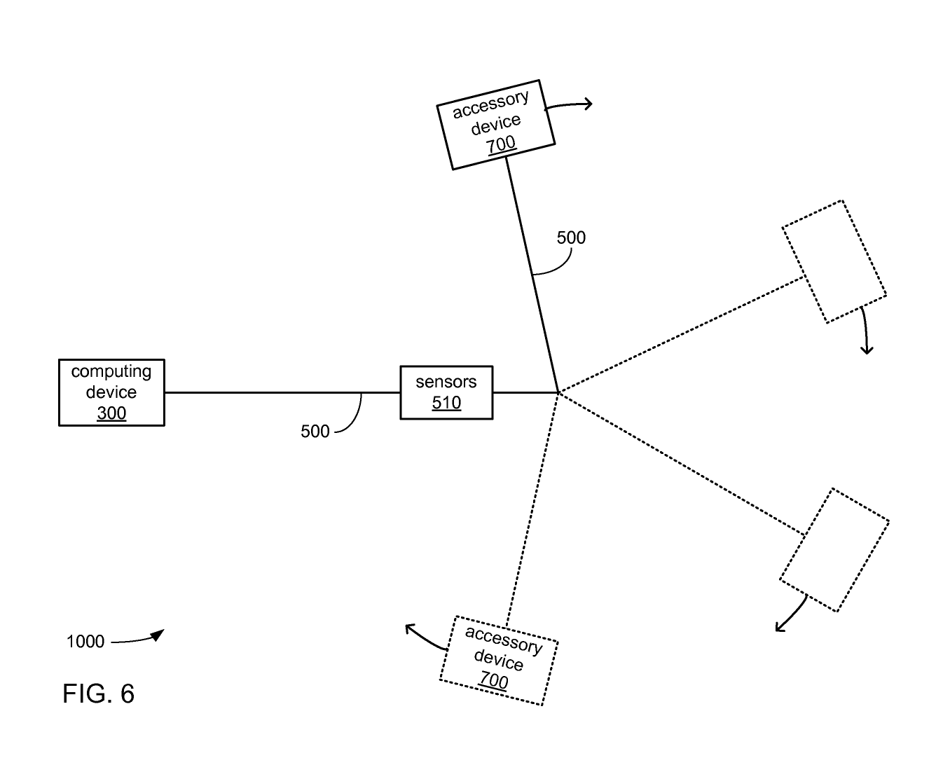

FIG. 6 illustrates an example of the use of one or more of the sensors 710 of an embodiment of the accessory device 700 to provide indications of movement of the accessory device 700 to the computing device 300, including movement that may be indicative of operator input to convey a command. As specifically depicted, the accessory device 700 is twirled by the cable 500 in a circular motion. As appreciable by those skilled in the art, such movement imparted to the accessory device 700 entails exertions of both centripetal and centrifugal forces thereon. Where the sensors 710 include one or more of the accelerometer 716, one or both of these forces may be detected and indications of one or both of these forces being detected conveyed to the computing device 300. Where the sensors 710 include the gyroscope 717, rotational motion imparted onto the accessory device 700 by twirling it may be detected and indications of such detected motion conveyed to the computing device 300. Further, such twirling of the accessory device 700 by the cable 500 entails a cyclic pattern of bending of the cable 500 that may be detected by the sensors 510 of the cable, resulting in indications of such cyclic bending being conveyed to the computing device 300. Thus, the use of either or both of the cable 500 and the accessory device 700 as input devices in a manner employing either or both of the sensors 510 and 710 is exemplified.

Returning to FIG. 1., in various embodiments, each of the processor components 150 and 350 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

In various embodiments, each of the storages 160 and 360 may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, each of the interfaces 190 and 390 may employ any of a wide variety of signaling technologies enabling computing devices to be coupled to other devices as has been described. Each of these interfaces may include circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

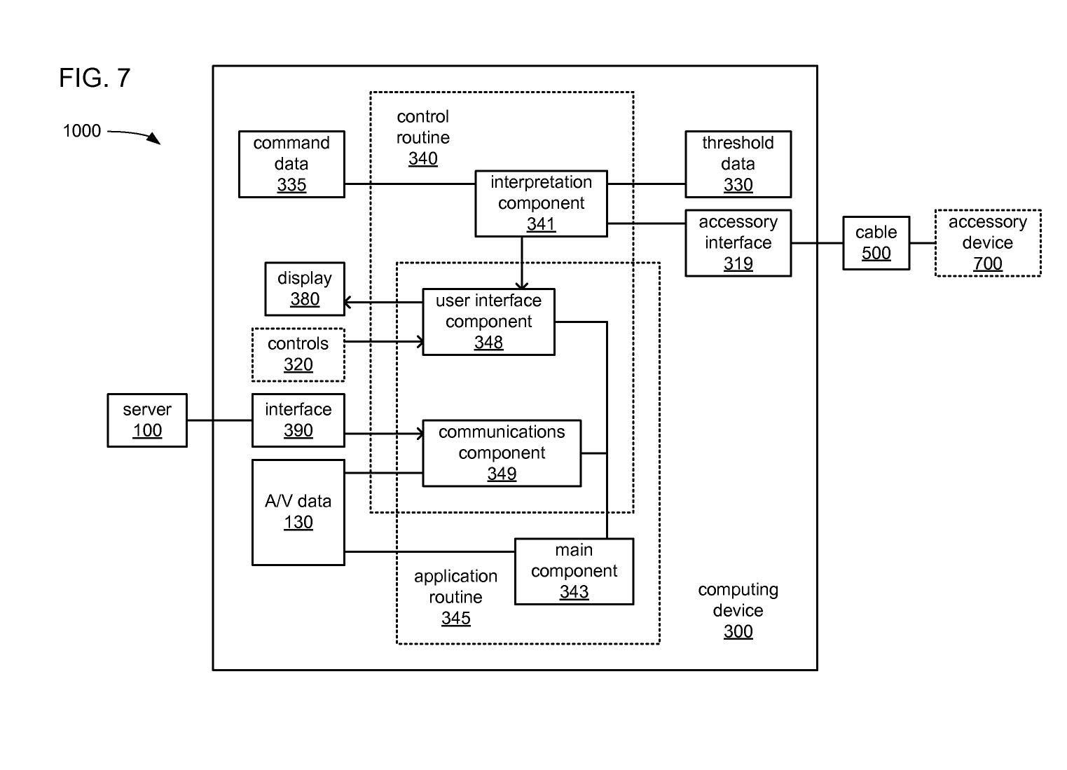

FIG. 7 is a simplified block diagram of a portion of an embodiment of the interaction system 1000 of FIG. 1. Specifically, aspects of the operating environment of the computing device 300 are depicted. In various embodiments, the control routine 340 and/or the application routine 345 may include one or more of an operating system, device drivers and/or application-level routines (e.g., so-called “software suites” provided on disc media, “applets” obtained from a remote server, etc.). Where an operating system is included, the operating system may be any of a variety of available operating systems appropriate for the processor component 350. Where one or more device drivers are included, those device drivers may provide support for any of a variety of other components, whether hardware or software components, of the computer system 300, the cable 500 and/or the accessory device 700.

Either or both of the control routine 340 and application routine 345 may include or be otherwise linked to a communications component 349 executable by the processor component 350 to operate the interface 390 to transmit and receive signals via the network 999 as has been described. Among the signals received may be signals conveying the A/V data 130 via the network 999. As familiar to those skilled in the art, each of these communications components is selected to be operable with whatever type of interface technology is selected to implement corresponding ones of the interfaces 190 and 390.

Either or both of the control routine 340 and application routine 345 may include or be otherwise linked to a user interface component 348 executable by the processor component 350 to operate the controls 320, the display 380 and/or another component to provide a user interface by which an operator of the computing device 300 may interact with one or both of the control routine 340 and the application routine 345. Thus, such a user interface may incorporate a visual portion for visual presentation on the display 380.

The control routine 340 may include an interpretation component 341 to operate the accessory interface 319 to receive indications of physical manipulation of the cable 500 and/or of movement of the accessory device 700. The interpretation component 341 may retrieve indications of one or more thresholds incorporated into the threshold data 330. The interpretation component 341 may employ one or more of such thresholds to distinguish physical manipulation of the cable 500 that is indicative of operator input to convey a command to the computing device 300 (and that may cause movement of one or more portions of the cable 500 relative to one or more other portions of the cable 500) from other physical manipulation of the cable 500 arising from other causes. By way of example, the cable 500 may be draped over objects or left dangling freely between the computing device 300 and the accessory device 700 such that other objects and/or other portions of the operator's body may come into contact with the cable 500 in a manner that is detected by the sensors 510 (as such contact may deflect a portion of the exterior of the cable relative to another portion of the cable). Thus, it is envisioned that the sensors 510 of the cable 500 may provide the computing device 300 with various indications of physical manipulation of the cable 500 that are in no way a result of the operator intentionally manipulating the cable 500 to provide operator input. Thus, by way of example, a lower threshold of pressure may be selected to distinguish relatively light pressure from the cable 500 simply being draped across a table (such that a portion of the exterior the cable may be moved to only a minor degree relative to another portion) from higher pressure indicative of a portion of the cable 500 being pinched between two digits of the operator's hand to provide operator input (such that there is more of such movement). Further, by way of example, an upper threshold of pressure may be selected distinguish pressure indicative of a portion of the cable 500 being pinched between digits of a hand as just described from a portion of the cable 500 being compressed with greater pressure as a result of a book being set upon it as it is draped across a table. Similarly, and by way of still another example, a lower threshold of temperature may be selected to distinguish the relatively moderate temperature of a touch of the cable 500 by an operator from a relatively lower temperature of what might be deemed a typical ambient environment.

By way of another example, the accessory device 700 may be left dangling at the end of the cable 500 such that the accessory device 700 is allowed to swing freely to a relatively limited degree. Thus, it is envisioned that the sensors 710 of the accessory device 700 may provide the computing device 300 with various indications of movement of the accessory device 700 that are in no way a result of the operator intentionally moving the accessory device 700 to provide operator input. Thus, by way of example, a lower threshold of acceleration and/or extent of rotational movement may be selected to distinguish relatively minimal acceleration and/or a relatively minimal extent of rotational movement consistent with the accessory device 700 being allowed to freely dangle at the end of the cable 500 from accelerations of greater magnitude and/or an extent of rotational movement that are consistent with the operator intentionally swinging or twirling the accessory device 700 at the end of the cable 500 to provide operator input. Further, by way of example, an upper threshold of magnitude of acceleration may be selected distinguish pressure indicative of the accessory device 700 accidentally being dropped onto a floor from a more moderate magnitude of acceleration consistent with the accessory device 700 being intentionally moved by an operator.

The interpretation component 341 effectively augments the user interface component 348, adding indications of operator input based on indications received from sensors of one or both of the cable 500 and the accessory device 700 to other indications of operator input that the user interface component 348 may receive from other components such as the controls 320, etc. Following distinguishing operator input from other physical manipulation of the cable 500 and/or other movement of the accessory device 700, the interpretation component 341 may further identify the command conveyed in the operator input based on characteristics of that operator input. In so doing, the interpretation component 341 may retrieve indications of a mapping of characteristics of detected input to commands from the command data 335. By way of example, it may be indicated in the command data 335 that a pinch occurring at a particular location along the cable 500 is to be interpreted as a selection command. By way of another example, a stroking of the cable 500 along the length of a particular portion of the cable 500 (e.g., a pinch between two or more digits of a hand that moves along the length of that portion) may be indicated in the command data 335 as indicative of a command to adjust a volume and/or to scroll through a selection of menu items visually presented as part of the user interface. By way of still another example, a twirling motion imparted to the accessory device 700 within a specified range of speed of rotation and/or having a specified direction of rotation may be indicated in the command data 335 as indicative of a command to adjust the speed at which audio and/or visual data is played (e.g., fast forward versus a normal playing speed, etc.).

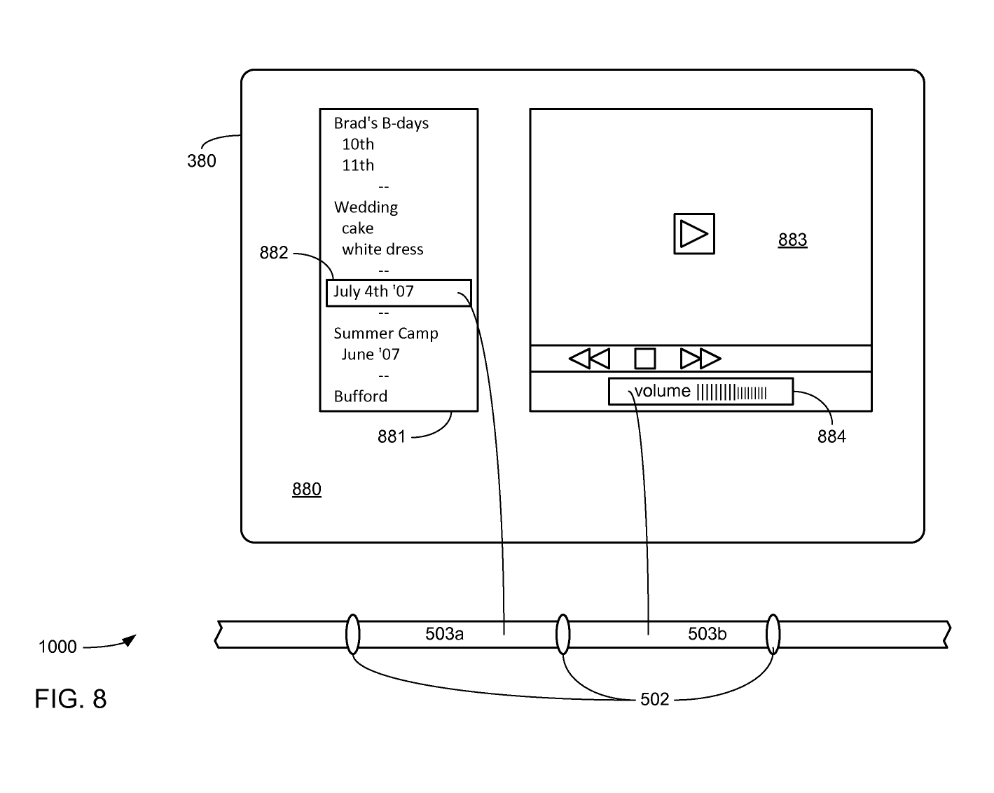

FIG. 8 illustrates an embodiment of a visual portion 880 of a user interface that may be provided by the user interface component 348 as augmented by operator input of commands via the interpretation component 341. As specifically depicted, a portion 503a of the cable 500 may be indicated in the command data 335 as mapped for scrolling such that a stroking of the cable 500 along the portion 503a may scroll a selection indicator 822 through menu items of a scrollable menu 881 of the user interface 880. A pinching of the cable 500 along the same portion 503a may also be mapped to effecting a selection of whatever menu item is highlighted by the selection indicator 822. As also specifically depicted, another portion 503b of the cable may be indicated in the command data 335 as mapped for adjusting a volume control 884 of the user interface 880 in a playback window 883 such that a stroking of the cable 500 along the portion 503b may adjust the volume of whatever audio is played in connection with operation of the playback window 883. As also specifically depicted, the exterior of the cable 500 may incorporate one or more surface formations 502 to provide a tactile indication to the operator of the computing device 300 of the locations of the portions 503a and 503b. By way of another example, bending of the cable 500 as exemplified in FIG. 3B may be mapped to a command to pause playback. By way of still another example, the twirling of the accessory device 700 by the cable 500 exemplified in FIG. 6 may be indicated by the command data 335 as mapped to a command to speed up playback and/or fast-forward to another portion of an audio/visual program of the A/V data 130.

Thus, the location along the length of the cable 500 may be a characteristic employed to identify one command from another. Also, the direction in which the cable 500 is stroked along its length may be a characteristic employed to identify one command from another (e.g., increase audio volume vs. decrease audio volume). Further, the direction in which the cable is bent may be a characteristic employed to identify one command from another (e.g., scroll left vs. scroll right).

Returning to FIG. 7, the application routine 345 may include a main component 343 to perform any of a variety of functions consistent with the nature of the application routine. As has been discussed, the application routine 345 may be any of a variety of types of application software, including software to play an audio and/or visual program of the A/V data 130. Thus, it may be that the user interface provided by the user interface component 348 is that of the application routine 345, which includes the main component 343 effecting retrieval of the A/V data 130 from the server 100 (via the communications component 349), and effecting the playback of audio and/or video of a program therefrom. In so doing, the user interface may visually present a visual portion resembling the visual portion 880 exemplified in FIG. 8, and the interpretation component 341 may enable control of such playback in a manner not unlike what was discussed in reference to FIG. 8. However, in other embodiments, the application routine 345 may be a video game enabling the operator to engage in multi-person play via the network 999 in which the A/V data 130 includes audio and/or imagery indicative of actions by other players, with the main component 343 coordinating the sending and receiving of such data to maintain synchronization of cause and effect in game play among the players. In such embodiments, physical manipulation of the cable 500 and/or movement of the accessory device 700 may be performed by the operator of the computing device 300 as part of the operator's participation in the playing of the video game.

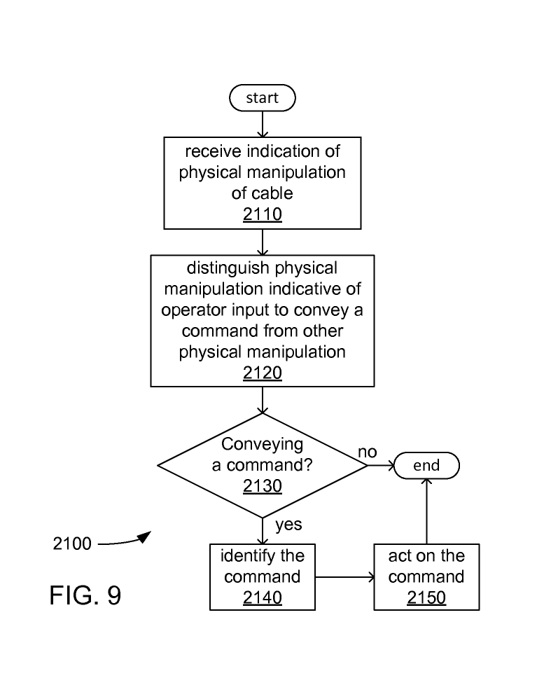

FIG. 9 illustrates one embodiment of a logic flow 2100. The logic flow 2100 may be representative of some or all of the operations executed by one or more embodiments described herein. More specifically, the logic flow 2100 may illustrate operations performed by the processor component 350 in executing at least one of the control routine 340 and the application routine 345, and/or performed by other component(s) of the computing device 300.

At 2110, a processor component of a computing device of an interaction system (e.g., the processor component 350 of the computing device 300 of the interaction system 1000) is caused to receive an indication of a physical manipulation of a cable communicatively coupled to the computing device (e.g., the cable 500). As has been explained, the cable may incorporate any of a variety of types of sensors to detect physical manipulation of the cable such as pinching, stroking and/or bending. As has also been explained, the cable may be detachable from the computing device.

At 2120, the physical manipulation of the cable is analyzed to distinguish physical manipulation that is indicative of operator input to convey a command from physical manipulation that isn't. As has been explained, one or more thresholds of characteristics of the physical manipulation of the cable may be employed (e.g., pressure, temperature, etc.) to perform such distinguishing of physical manipulation indicative of operator input from other physical manipulation.

At 2130, if the physical manipulation is determined to not be indicative of operator input conveying a command, then the physical manipulation is not acted upon. However, if the physical manipulation is determined to be indicative of such operator input, then the command that is so conveyed is identified at 2140, and acted upon at 2150. As has been explained, a mapping of different physical manipulations of the cable at different locations along its length may be employed to determine what command is conveyed.

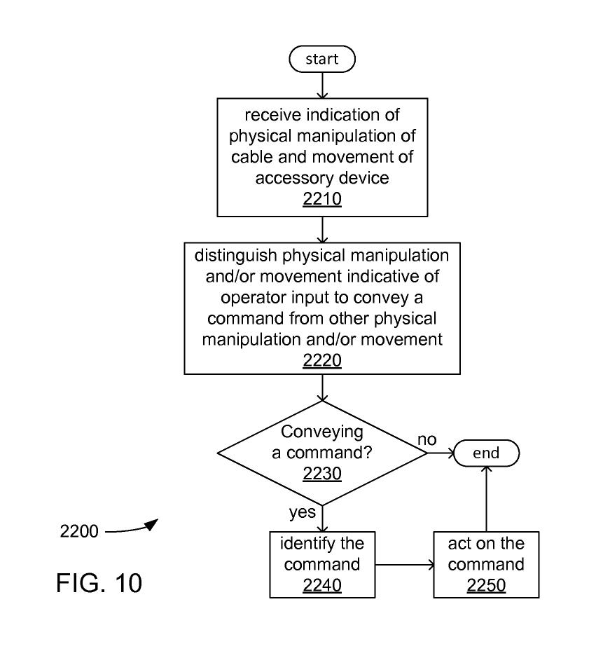

FIG. 10 illustrates one embodiment of a logic flow 2200. The logic flow 2200 may be representative of some or all of the operations executed by one or more embodiments described herein. More specifically, the logic flow 2200 may illustrate operations performed by the processor component 350 in executing at least one of the control routine 340 and the application routine 345, and/or performed by other component(s) of the computing device 300.

At 2210, a processor component of a computing device of an interaction system (e.g., the processor component 350 of the computing device 300 of the interaction system 1000) is caused to receive an indication of a physical manipulation of a cable communicatively coupled to the computing device (e.g., the cable 500) and/or a movement of an accessory device communicatively coupled to the computing device via the cable (e.g., the accessory device 700). As has been explained, in a manner paralleling the cable, the accessory device may incorporate any of a variety of types of sensors to movement such as translational and/or rotational movement (including twirling at the end of the cable). As has also been explained, the cable may be detachable from one or both of the computing device and the accessory device.

At 2220, the physical manipulation of the cable and/or the movement of the accessory device is analyzed to distinguish physical manipulation and/or movement that is indicative of operator input to convey a command from physical manipulation and/or movement that isn't. As has been explained, one or more thresholds of characteristics of the movement of the accessory device may be employed (e.g., magnitude of acceleration, extent of rotation, etc.) to perform such distinguishing of movement indicative of operator input from other movement.

At 2230, if neither of the physical manipulation of the cable or movement of the accessory device is determined to be indicative of operator input conveying a command, then the physical manipulation and/or movement are not acted upon. However, if one or both of the physical manipulation and movement are determined to be indicative of such operator input, then the command that is identified at 2240, and acted upon at 2250. As has been explained, a mapping of different physical manipulations of the cable at different locations along its length and/or movements of the accessory device in various directions and/or with various accelerations may be employed to determine what command is conveyed.

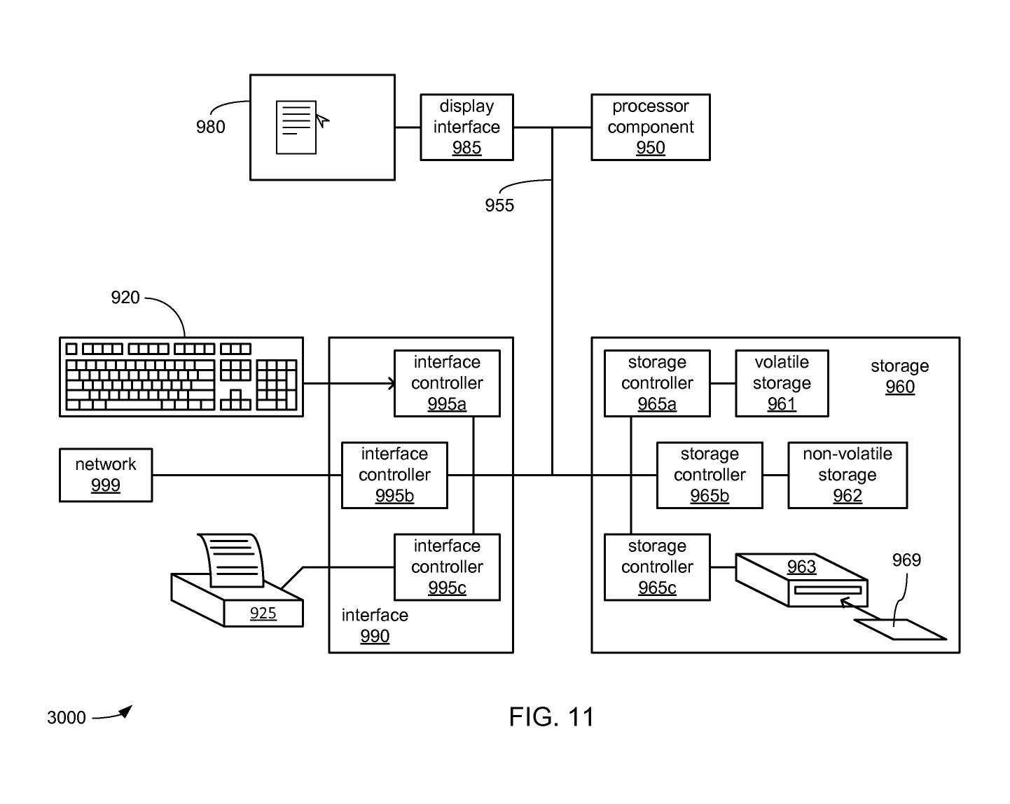

FIG. 11 illustrates an embodiment of an exemplary processing architecture 3000 suitable for implementing various embodiments as previously described. More specifically, the processing architecture 3000 (or variants thereof) may be implemented as part of the computing device 300. It should be noted that components of the processing architecture 3000 are given reference numbers in which the last two digits correspond to the last two digits of reference numbers of at least some of the components earlier depicted and described as part of one or more of the computing devices 100a-c and 300. This is done as an aid to correlating components of each.

The processing architecture 3000 may include various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor component, the processor component itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

As depicted, in implementing the processing architecture 3000, a computing device may include at least a processor component 950, a storage 960, an interface 990 to other devices, and a coupling 955. As will be explained, depending on various aspects of a computing device implementing the processing architecture 3000, including its intended use and/or conditions of use, such a computing device may further include additional components, such as without limitation, a display interface 985.

The coupling 955 may include one or more buses, point-to-point interconnects, transceivers, buffers, crosspoint switches, and/or other conductors and/or logic that communicatively couples at least the processor component 950 to the storage 960. Coupling 955 may further couple the processor component 950 to one or more of the interface 990, the audio subsystem 970 and the display interface 985 (depending on which of these and/or other components are also present). With the processor component 950 being so coupled by couplings 955, the processor component 950 is able to perform the various ones of the tasks described at length, above, for whichever one(s) of the aforedescribed computing devices implement the processing architecture 3000. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 (corresponding to one or more of the processor components 150 and 350) may include any of a wide variety of commercially available processors, employing any of a wide variety of technologies and implemented with one or more cores physically combined in any of a number of ways.

As previously discussed, the storage 960 (corresponding to one or more of the storages 160 and 360) may be made up of one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly including multiple distinct types of storage is in recognition of the commonplace use of more than one type of storage device in computing devices in which one type provides relatively rapid reading and writing capabilities enabling more rapid manipulation of data by the processor component 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 to implement various embodiments may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine including a sequence of instructions to be executed by the processor component 950 to implement various embodiments may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (possibly corresponding to one or more of the interfaces 190 and 390) may employ any of a variety of signaling technologies corresponding to any of a variety of communications technologies that may be employed to communicatively couple a computing device to one or more other devices. Again, one or both of various forms of wired or wireless signaling may be employed to enable the processor component 950 to interact with input/output devices (e.g., the depicted example keyboard 920 or printer 925) and/or other computing devices, possibly through a network (e.g., the network 999) or an interconnected set of networks. In recognition of the often greatly different character of multiple types of signaling and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network made up of one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data signaled by those persons via gestures and/or facial expressions, laser printers, inkjet printers, mechanical robots, milling machines, etc.

Where a computing device is communicatively coupled to (or perhaps, actually incorporates) a display (e.g., the depicted example display 980, corresponding to one or more of the displays 180 and 380), such a computing device implementing the processing architecture 3000 may also include the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

More generally, the various elements of the computing devices described and depicted herein may include various hardware elements, software elements, or a combination of both. Examples of hardware elements may include devices, logic devices, components, processors, microprocessors, circuits, processor components, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

An example of an apparatus to receive commands includes a processor component, an accessory interface communicatively coupled to the processor component to receive from a sensor of a cable an indication of first movement of the cable, and an interpretation component for execution by the processor component to determine whether the first movement indicates a command and to identify the command.

The above example of an apparatus in which the interpretation component is to determine whether the first movement indicates a command based on a first threshold and to identify the command based on a characteristic of the first movement.

Either of the above examples of an apparatus in which the first threshold includes one of a pressure threshold, a thermal threshold, a vibration amplitude threshold, a strain threshold and a proximity threshold, and the characteristic includes one of a location on the cable at which the first movement is detected and a direction of the first movement.

Any of the above examples of an apparatus in which the command includes one of a scrolling command, a selection command, a volume adjustment command and a speed adjustment command.

Any of the above examples of an apparatus in which the apparatus includes a user interface component for execution by the processor component to visually present a visual portion of a user interface on a display and to modify the visual portion in response to the command.

Any of the above examples of an apparatus in which the accessory interface is to receive an indication of second movement of an accessory device communicatively coupled to the cable, and the interpretation component to determine whether the second movement indicates a command.

Any of the above examples of an apparatus in which the interpretation component is to determine whether the second movement indicates a command based on a second threshold.

Any of the above examples of an apparatus in which the second threshold includes one of a magnitude of a centripetal force, a magnitude of a centrifugal force, a rotational speed and an extent of rotation.

Any of the above examples of an apparatus in which the apparatus includes the accessory device, the accessory device including another sensor to detect the second movement and to convey the indication of the second movement to the accessory interface.

Any of the above examples of an apparatus in which the other sensor includes one of a compass, an accelerometer and a gyroscope.

Any of the above examples of an apparatus in which the apparatus includes the cable, the cable communicatively coupled to the accessory interface.

Any of the above examples of an apparatus in which the sensor includes one of a pressure sensor, a vibration sensor, a strain sensor, a thermal sensor, a light detector and a proximity sensor.

An example of another apparatus to receive commands includes a processor component, an accessory interface communicatively coupled to the processor component to receive from a first sensor of a cable communicatively coupled to the accessory interface an indication of physical manipulation of the cable and to receive from a second sensor of an accessory device communicatively coupled to the cable an indication of a movement of the accessory device, and an interpretation component for execution by the processor component to determine whether one of the physical manipulation and the movement indicates a command.

The above example of another apparatus in which the interpretation component is to determine whether the physical manipulation indicates a command based on a first threshold.

Either of the above examples of another apparatus in which the first threshold includes one of a pressure threshold, a thermal threshold, a vibration amplitude threshold, a strain threshold and a proximity threshold.

Any of the above examples of another apparatus in which the interpretation component is to determine whether the movement indicates a command based on a second threshold.

Any of the above examples of another apparatus in which the second threshold includes one of a magnitude of a centripetal force, a magnitude of a centrifugal force, a rotational speed and an extent of rotation.

Any of the above examples of another apparatus in which the interpretation component is to identify the command.

Any of the above examples of another apparatus in which the command includes one of a scrolling command, a selection command, a volume adjustment command and a speed adjustment command.

Any of the above examples of another apparatus in which the apparatus includes a user interface component for execution by the processor component to provide a user interface and to modify a portion of the user interface in response to the command.

Any of the above examples of another apparatus in which the apparatus includes at least one of the cable and the accessory device.

Any of the above examples of another apparatus in which the first sensor includes one of a pressure sensor, a vibration sensor, a strain sensor, a thermal sensor, a light detector and a proximity sensor.

Any of the above examples of another apparatus in which the second sensor includes one of a compass, an accelerometer and a gyroscope.

An example of a computer-implemented method for receiving commands includes receiving from a sensor of a cable an indication of first movement of the cable, determining whether the first movement indicates a command, and identifying the command based on a determination of whether the first movement indicates a command.

The above example of a computer-implemented method in which the command includes one of a scrolling command, a selection command, a volume adjustment command and a speed adjustment command.

Either of the above examples of a computer-implemented method in which the method includes visually presenting a visual portion of a user interface on a display, and modifying the visual portion in response to the command.

Any of the above examples of a computer-implemented method in which the method includes determining whether the first movement indicates a command based on a first threshold, and identifying the command based on a characteristic of the first movement.

Any of the above examples of a computer-implemented method in which the first threshold includes one of a pressure threshold, a thermal threshold, a vibration amplitude threshold, a strain threshold and a proximity threshold, and the characteristic includes one of a location along the cable and a direction of the first movement.

Any of the above examples of a computer-implemented method in the method includes receiving from a sensor of an accessory device communicatively coupled to the cable an indication of a second movement of the accessory device, and determining whether the second movement indicates a command.

Any of the above examples of a computer-implemented method in which the method includes determining whether the second movement indicates a command based on a second threshold.

Any of the above examples of a computer-implemented method in which the second threshold includes one of a centripetal force, a centrifugal force, a rotational speed and an extent of rotation.

An example of at least one machine-readable storage medium includes instructions that when executed by a computing device, cause the computing device to receive from a sensor of a cable communicatively coupled to the computing device an indication of a first movement of the cable, determine whether the first movement indicates a command, and identify the command based on a determination of whether the first movement indicates a command.

The above example of at least one machine-readable storage medium in which the command includes one of a scrolling command, a selection command, a volume adjustment command and a speed adjustment command.

Either of the above examples of at least one machine-readable storage medium in which the computing device is caused to visually present a visual portion of a user interface on a display of the computing device, and modify the visual portion in response to the command.

Any of the above examples of at least one machine-readable storage medium in which the computing device is caused to determine whether the first movement indicates a command based on a first threshold, and to identify the command based on a characteristic of the first movement.

Any of the above examples of at least one machine-readable storage medium in which the first threshold includes one of a pressure threshold, a thermal threshold, a vibration amplitude threshold, a strain threshold and a proximity threshold, and the characteristic includes one of a location along the cable and a direction of the first movement.

Any of the above examples of at least one machine-readable storage medium in which the computing device is caused to receive from a sensor of an accessory device communicatively coupled to the cable an indication of a second movement of the accessory device, and determine whether the second movement indicates a command.

Any of the above examples of at least one machine-readable storage medium in which the computing device is caused to determine whether the second movement indicates a command based on a second threshold.

Any of the above examples of at least one machine-readable storage medium in which the second threshold includes one of a centripetal force, a centrifugal force, a rotational speed and an extent of rotation.

An example of still another apparatus to receive commands includes an accessory device including a first sensor to detect movement of the accessory device and an accessory interface to transmit an indication of the movement to a computing device, and a cable communicatively coupled the accessory interface and to communicatively couple the accessory interface to the computing device, the cable including a second sensor to detect physical manipulation of the cable and to transmit an indication of the physical manipulation to the computing device.

The above example of still another apparatus in which the accessory device includes one of an earphone, a headphone, a speaker, a mouse, a touchpad, a trackball and a camera.

Either of the above examples of still another apparatus in which the first sensor includes one of a compass, an accelerometer and a gyroscope.

Any of the above examples of still another apparatus in which the first sensor is to detect one of swinging the accessory device by the cable and twirling the accessory device by the cable.

Any of the above examples of still another apparatus in which the second sensor includes one of a pressure sensor, a vibration sensor, a strain sensor, a thermal sensor, a light detector and a proximity sensor.

Any of the above examples of still another apparatus in which the second sensor is to detect one of pinching, stroking and bending of the cable.

Any of the above examples of still another apparatus in which the cable includes a conductor to convey at least one of a first signal generated by the first sensor to indicate the movement to the computing device and a second signal generated by the second sensor to indicate the physical manipulation to the computing device.

Any of the above examples of still another apparatus in which the exterior surface of the cable includes a surface formation to indicate a location at which the cable may be physically manipulated to convey a command to the computing device.

Any of the above examples of still another apparatus in which the accessory device includes one of an EEG sensor and a fNIR sensor to detect brain activity.

An example of an apparatus for receiving commands includes means for performing any of the above examples.

An example of at least one machine readable storage medium includes instructions that when executed by a computing device, causes the computing device to perform any of the above examples.

1-25. (canceled)

26. An apparatus comprising:
a processor component;
an accessory interface communicatively coupled to the processor component to receive from a sensor of a cable an indication of first movement of the cable; and
an interpretation component for execution by the processor component to determine whether the first movement indicates a command and to identify the command.

27. The apparatus of claim 26, the interpretation component to determine whether the first movement indicates a command based on a first threshold and to identify the command based on a characteristic of the first movement.

28. The apparatus of claim 26, comprising a user interface component for execution by the processor component to visually present a visual portion of a user interface on a display and to modify the visual portion in response to the command.

29. The apparatus of claim 26, the accessory interface to receive an indication of second movement of an accessory device communicatively coupled to the cable, and the interpretation component to determine whether the second movement indicates a command.

30. The apparatus of claim 29, comprising the accessory device, the accessory device comprising another sensor to detect the second movement and to convey the indication of the second movement to the accessory interface.

31. The apparatus of claim 30, the other sensor comprising one of a compass, an accelerometer or a gyroscope.

32. The apparatus of claim 26, comprising the cable, the cable communicatively coupled to the accessory interface.

33. An apparatus comprising:
a processor component;
an accessory interface communicatively coupled to the processor component to receive from a first sensor of a cable communicatively coupled to the accessory interface an indication of physical manipulation of the cable and to receive from a second sensor of an accessory device communicatively coupled to the cable an indication of a movement of the accessory device; and
an interpretation component for execution by the processor component to determine whether one of the physical manipulation and the movement indicates a command.

34. The apparatus of claim 33, the interpretation component to determine whether the physical manipulation indicates a command based on a first threshold.

35. The apparatus of claim 33, the interpretation component to determine whether the movement indicates a command based on a second threshold.

36. The apparatus of claim 33, the interpretation component to identify the command.

37. The apparatus of claim 33, comprising a user interface component for execution by the processor component to provide a user interface and to modify a portion of the user interface in response to the command.

38. A computing-implemented method comprising:
receiving from a sensor of a cable an indication of first movement of the cable;
determining whether the first movement indicates a command; and
identifying the command based on a determination of whether the first movement indicates a command.

39. The computer-implemented method of claim 38, the command comprising one of a scrolling command, a selection command, a volume adjustment command or a speed adjustment command.

40. The computer-implemented method of claim 38, comprising:
visually presenting a visual portion of a user interface on a display; and
modifying the visual portion in response to the command.

41. The computer-implemented method of claim 38, comprising determining whether the first movement indicates a command based on a first threshold; and
identifying the command based on a characteristic of the first movement.

42. The computer-implemented method of claim 38, comprising:
receiving from a sensor of an accessory device communicatively coupled to the cable an indication of a second movement of the accessory device; and
determining whether the second movement indicates a command.

43. The computer-implemented method of claim 42, comprising determining whether the second movement indicates a command based on a second threshold.

44. At least one machine-readable storage medium comprising instructions that when executed by a computing device, cause the computing device to:
receive from a sensor of a cable communicatively coupled to the computing device an indication of a first movement of the cable;
determine whether the first movement indicates a command; and
identify the command based on a determination of whether the first movement indicates a command.

45. The at least one machine-readable storage medium of claim 44, the computing device caused to:
visually present a visual portion of a user interface on a display of the computing device; and
modify the visual portion in response to the command.

46. The at least one machine-readable storage medium of claim 44, the computing device caused to determine whether the first movement indicates a command based on a first threshold, and to identify the command based on a characteristic of the first movement.

47. The at least one machine-readable storage medium of claim 46, the first threshold comprising one of a pressure threshold, a thermal threshold, a vibration amplitude threshold, a strain threshold or a proximity threshold, and the characteristic comprising one of a location along the cable or a direction of the first movement.

48. The at least one machine-readable storage medium of claim 44, the computing device caused to:
receive from a sensor of an accessory device communicatively coupled to the cable an indication of a second movement of the accessory device; and
determine whether the second movement indicates a command.

49. The at least one machine-readable storage medium of claim 48, the computing device caused to determine whether the second movement indicates a command based on a second threshold.

50. The at least one machine-readable storage medium of claim 49, the second threshold comprising one of a centripetal force, a centrifugal force, a rotational speed or an extent of rotation.
